(19) United States
(12) Patent Application Publication
(10) Pub. No.: US 2026/0354349 A1
(43) Pub. Date: Nov. 12, 2026

(54) ROPE TOY

(71) Applicant: SHENZHEN CHEERBLE TECHNOLOGY CO., LTD., Shenzhen (CN)

(72) Inventors: Weicheng Guo, Shenzhen (CN); Jinbin Xie, Shenzhen (CN)

(21) Appl. No.: 19/716,442

(22) Filed: Jun. 23, 2026

(30) Foreign Application Priority Data
Sep. 25, 2025 (CN) 202522075677.8

(51) Int. Cl. A01K 15/02

(52) U.S. Cl. CPC A01K 15/025

(57) ABSTRACT

A rope toy includes a housing, an actuator, and a rope. The housing includes a first shell and a second shell detachably connected to the first shell. The first shell and the second shell together define a receiving cavity. At least one of the first shell or the second shell is made of expanded thermoplastic polyurethane. The actuator is removably mounted within the receiving cavity. The rope has a first end connected to the actuator and a second end extending outside the housing. The actuator drives the rope to move relative to the housing. The rope toy has a modular, detachable structure that enables independent replacement or repair of the actuator, rope, and housing, resulting in low maintenance costs and a long service life.

### CROSS-REFERENCE TO RELATED APPLICATION(S)

The present application claims the benefit of and priority to Chinese Patent Application No. 202522075677.8, filed on Sep. 25, 2025, with the China National Intellectual Property Administration, the entire contents of which are incorporated herein by reference.

### FIELD

The present disclosure relates to pet accessories, and particularly to a rope toy.

### BACKGROUND

Conventional rope toys often integrate a drive assembly and a housing into a single, non-modular product. When the housing is damaged or a battery of the drive assembly is depleted, a user may need to discard the entire rope toy rather than replacing only the damaged component, which increases cost and wastes resources.

### SUMMARY

In one aspect, the present application provides a rope toy that includes a housing, an actuator, and a rope. The housing includes a first shell and a second shell detachably connected to the first shell, and the first shell and the second shell cooperatively define a receiving cavity. At least one of the first shell or the second shell comprises expanded thermoplastic polyurethane. The actuator is removably disposed within the receiving cavity. The rope is connected to the actuator, and at least one end of the rope extends outside the housing. In response to the actuator driving the rope, the rope moves relative to at least one of the first shell and the second shell.

Because the first shell and the second shell are detachably connected to each other and the actuator is removably disposed within the receiving cavity, the actuator may be quickly disassembled, replaced, or recharged, and a damaged housing may be replaced without discarding the entire rope toy, thereby reducing maintenance cost and extending service life.

### BRIEF DESCRIPTION OF THE DRAWINGS

Implementations of the present technology will now be described, by way of example only, with reference to the attached figures, wherein:

FIG. 1 is a diagrammatic view of a rope toy according to one embodiment of the present application.

FIG. 2 is an exploded view of the rope toy shown in FIG. 1.

FIG. 3 is another exploded view of the rope toy shown in FIG. 1, viewed from a different angle.

FIG. 4 is a diagrammatic view showing a rope-fixing shell, a rope-fixing plate, and the rope of the rope toy shown in FIG. 1.

FIG. 5 is a cross-sectional view of the rope toy shown in FIG. 1 with the actuator removed.

FIG. 6 is a diagrammatic view of a rope toy according to another embodiment of the present application.

FIG. 7 is a diagrammatic view of a rope toy according to yet another embodiment of the present application.

FIG. 8 is a diagrammatic view of an actuator of the rope toy shown in FIG. 1.

FIG. 9 is another diagrammatic view of the actuator shown in FIG. 8.

FIG. 10 is a diagrammatic view of the actuator shown in FIG. 8 with the bottom shell removed.

FIG. 11 is an exploded view of the actuator shown in FIG. 8.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

For clarity, terms such as “first,” “second,” etc. are used for distinction and do not limit the scope. Unless otherwise stated, a first direction X, a second direction Y, and a third direction Z may be mutually perpendicular. The drawings are schematic and not necessarily to scale

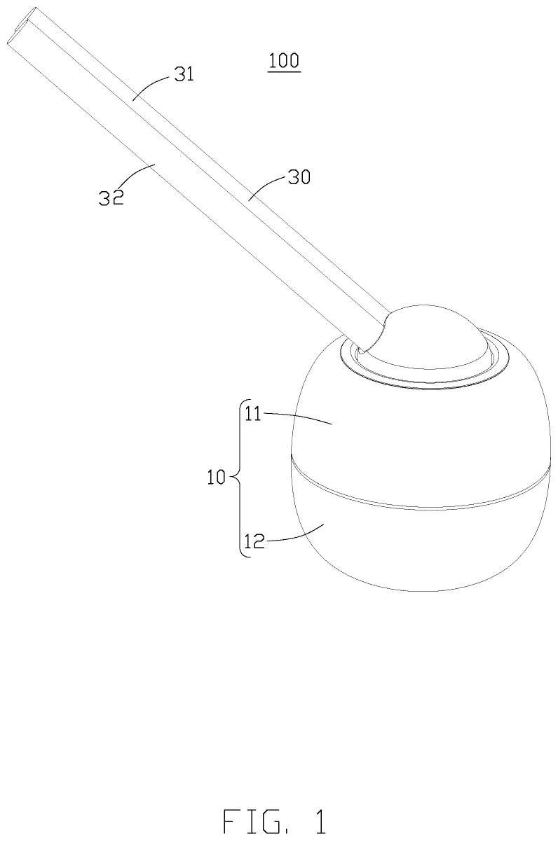

Referring to FIGS. 1, 2, and 3, a rope toy 100 is provided according to one embodiment of the present application. The rope toy 100 includes a housing 10, an actuator 20, and a rope 30. The actuator 20 is removably disposed in the housing 10. The rope 30 includes a first end 31 and a second end 32 opposite to the first end 31. A portion of the rope 30 is connected to the actuator 20, and at least one of the first end 31 and the second end 32 of the rope 30 extends outside the housing 10. In some embodiments, either the first end 31 or the second end 32 of the rope 30 is connected to the actuator 20 and the second end 32 extends outside the housing 10. In other embodiments, an intermediate portion of the rope 30 between the first end 31 and the second end 32 is connected to the actuator 20, and both the first end 31 and the second end 32 extend outside the housing 10, so that the actuator 20 may simultaneously drive two free ends of the rope 30 to provide multi-point interactive stimulation to a pet. The actuator 20 is configured to drive the rope 30 to move relative to the housing 10, so that a pet may chase, pounce on, or otherwise interact with the rope 30.

The housing 10 includes a first shell 11 and a second shell 12 detachably connected to the first shell 11. The first shell 11 and the second shell 12 together define a receiving cavity 13, and the actuator 20 is removably disposed in the receiving cavity 13. At least one of the first shell 11 or the second shell 12 is made of expanded thermoplastic polyurethane (E-TPU).

In the present application, the housing 10 employs a split-typed design. Because the first shell 11 and the second shell 12 are detachably connected to each other and the actuator 20 is removably disposed in the receiving cavity 13, the actuator 20 may be quickly disassembled, replaced, or recharged. When the housing 10 is damaged, only the housing 10 needs to be replaced, and the user has no need to discard the entire rope toy 100. The maintenance cost is thereby reduced. In addition, the E-TPU housing 10 will not be easily crumbled into pieces or particles, which are then ingested by a pet, after being repeated pulled and bitten by the pet. The housing 10 therefore has a longer service life than many rubber housings. Due to the high elasticity and low density of E-TPU, the housing 10 will produce less noise during collision with other objects, and may even float on water, thereby meeting the needs of the pet in various scenarios such as land and water. The actuator 20 drives the rope 30 to perform swinging and rotating motions so as to stimulate the pet's hunting and play instincts.

In at least one embodiment, the portion of the rope 30 passes through the first shell 11 and extends into the receiving cavity 13, and the second end 32 extends outside the housing 10. The actuator 20 drives the rope 30 to swing or rotate relative to at least one of the first shell 11 or the second shell 12. In other embodiments, the portion of the rope 30 may pass through the second shell 12 and extend into the receiving cavity 13. By connecting the rope 30 to the actuator 20 inside the housing 10, the number and size of openings provided on the housing 10 for receiving the rope 30 are reduced, thereby lowering the risk of the pet's claws, teeth, or hair being caught in the openings.

In at least one embodiment, the rope toy 100 further includes a rope-fixing shell 40. The first shell 11 defines a first opening 111, and the first opening 111 communicates the receiving cavity 13 with the external environment. The rope-fixing shell 40 is rotatably disposed in the first opening 111 and defines a second opening 401. The portion of the rope 30 passes through the second opening 401 of the rope-fixing shell 40 and extends into the receiving cavity 13 to connect with the actuator 20. The actuator 20 drives the rope-fixing shell 40 and the rope 30 to rotate relative to the first shell 11. As one example, a diameter of the rope 30 is substantially equal to a diameter of the second opening 401, thereby reducing a gap between the rope 30 and an inner wall of the second opening 401 and preventing the pet's claws or teeth from being caught by the gap. The rope-fixing shell 40 and the rope 30 may also be removed and replaced together as a module, so that only worn parts (i.e., the rope 30 and/or the rope-fixing shell 40) need to be replaced.

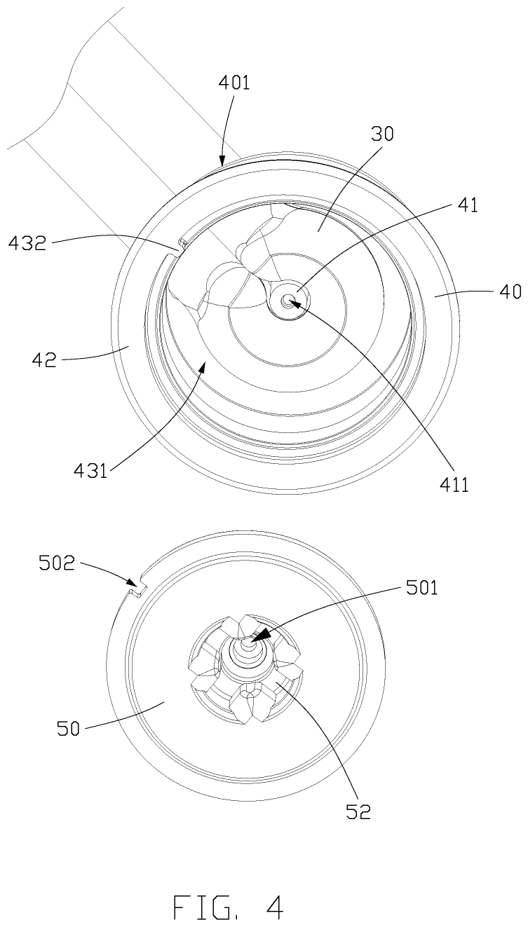

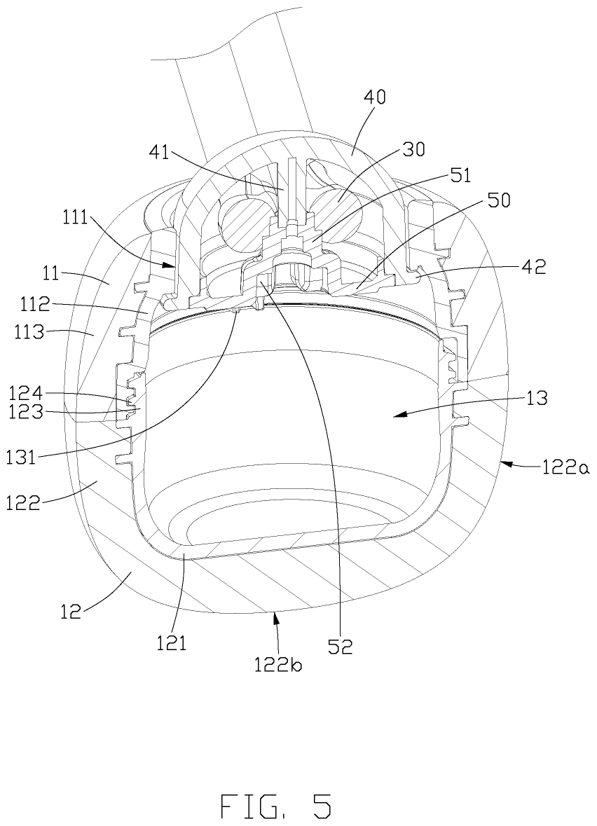

Referring to FIGS. 4 and 5, in at least one embodiment, the rope toy 100 further includes a rope-fixing plate 50 disposed within the receiving cavity 13. The rope-fixing plate 50 is connected to the actuator 20 and to the rope-fixing shell 40. The rope-fixing shell 40 includes a fixing post 41 on a side facing toward the receiving cavity 13. The portion of the rope 30 is connected to the fixing post 41 and is disposed between the rope-fixing shell 40 and the rope-fixing plate 50. The rope-fixing plate 50 includes a plurality of clamping portions 51 on a side facing toward the rope 30, and the clamping portions 51 abut against the rope 30.

The rope-fixing plate 50 is provided with a first fixing hole 501, and the fixing post 41 is provided with a second fixing hole 411. A screw rod of a screw passes through the first fixing hole 501 and is threaded into the second fixing hole 411. A screw head of the screw presses the rope-fixing plate 50 toward the fixing post 41, thereby providing an adjustable clamping force. An elastic washer or a lock washer may be disposed between the screw head and the rope-fixing plate 50. Fine teeth or anti-slip patterns may be formed on a surface of each clamping portion 51. An elastic protective sheet may be interposed between the rope 30 and clamping portion 51 to distribute compressive stress. This arrangement facilitates long-term maintenance by allowing the rope 30 to be retightened or replaced. Because the rope-fixing plate 50 is connected to the actuator 20, an effective transmission path is established from the actuator 20 to the rope 30, so that the rope 30 may be driven to swing and rotate to attract the pet.

In other embodiments, the rope-fixing plate 50 may be omitted. The portion of the rope 30 passing through the first shell 11 may be fixed within the receiving cavity 13 and connected to the actuator 20 by any suitable means. For example, the rope 30 may be connected to the actuator 20 by a rope-end bulge mating with an undercut groove; a radially expanding metal or engineering-plastic crimping sleeve; an axial lock using a tapered snap ring and wedge; a T-shaped or mushroom-head anchor that is inserted and then back-engaged; or a secondary over-molded anchor formed by insert molding.

In at least one embodiment, an edge of the rope-fixing shell 40 extends outwardly to form a limiting flange 42. The limiting flange 42 abuts against a side of the first shell 11 proximate to the first opening 111, so that the rope-fixing shell 40 remains in the first opening 111 during rotation. In other embodiments, other structures may be used to allow the rope-fixing shell 40 to rotate relative to the first shell 11 while preventing the rope-fixing shell 40 to disengage from the first shell 11 in an axial direction, and the suitable structure may include an annular groove cooperating with an elastic snap ring; a bayonet rotary-lock structure; circumferentially distributed elastic tabs engaging a limiting flange; a miniature ball or sliding bearing paired with a shaft-shoulder retaining ring; or a ball-and-socket joint combined with a sealing ring.

In at least one embodiment, an inner side surface of the rope-fixing shell 40 facing toward the receiving cavity 13 is recessed to form a receiving groove 431. The portion of the rope 30 and the rope-fixing plate 50 are disposed within the receiving groove 431. An outer side surface of the rope-fixing shell 40 facing away from the receiving cavity 13 protrudes from the first shell 11, and the outer side surface is curved. The exposed outer side surface is therefore smooth and substantially free of sharp edges, making it more difficult for the pet to establish a biting fulcrum on the outer side surface during biting, patting, or butting processes. In one specific embodiment, the outer side surface is hemispherical.

In at least one embodiment, a center region of a side surface of the rope-fixing plate 50 facing away from the rope 30 is provided with a spline sleeve 52. A spline 21 at one end of the output shaft 224 of the actuator 20 meshes with the spline sleeve 52. The engagement between the spline 21 and the spline sleeve 52 achieve coaxial alignment and reliable torque transmission, and also provides self-centering and anti-slip advantages during assembly, thereby enabling the actuator 20 to reliably drive the rope 30 to move. In other embodiments, torque transmission between the output shaft 224 of the actuator 20 and the rope-fixing plate 50 may be realized through: a D-shaped shaft received in a corresponding D-shaped bore; a hexagonal shaft received in a corresponding hexagonal bore; a flat key or Woodruff key connection; a friction-fit tapered bushing interference connection; an eccentric drive comprising a pinion gear meshing with a circumferential ring gear; or a crank-and-eccentric-wheel mechanism driving an oscillating output link.

In at least one embodiment, a latch block 432 protrudes from an inner side surface of the rope-fixing shell 40, and a latch slot 502 is provided on an outer edge of the rope-fixing plate 50. The latch block 432 is retained within the latch slot 502, so that the rope-fixing plate 50 and the rope-fixing shell 40 are circumferentially locked together to prevent relative rotation therebetween in a circumferential direction. When driven by the actuator 20, slippage may be avoided between the rope-fixing plate 50 and the rope-fixing shell 40. In at least one embodiment, a plurality of latch blocks 432 and a plurality of latch slots 502 may be circumferentially distributed to balance load. A small clearance or lubrication layer may be provided at each engagement position to reduce noise.

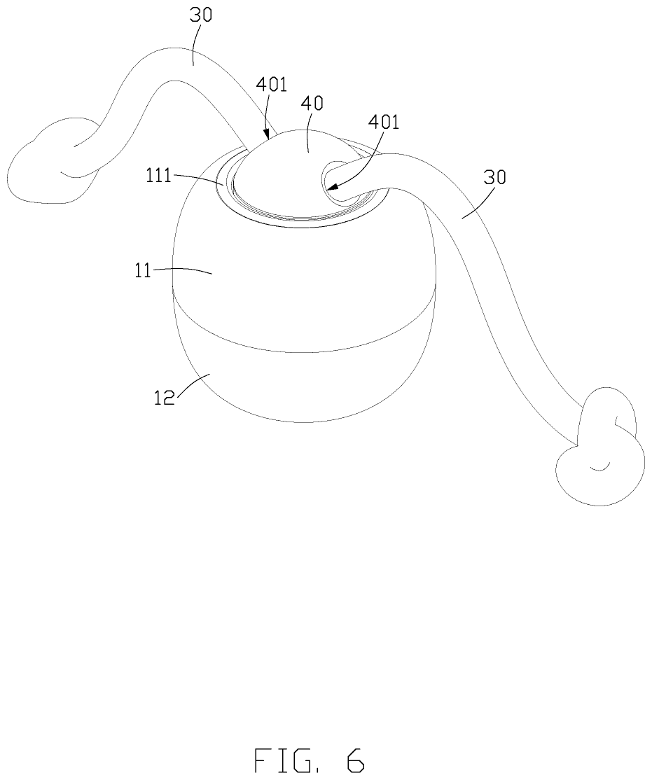

Referring to FIG. 6, in another embodiment, the number of second openings 401 is two or more. The rope 30 may extend through one or more of the plurality of second openings 401. In some implementations, each second opening 401 receives a respective rope 30, so that a plurality of ropes 30 extend outward through the plurality of second openings 401. In other implementations, a single rope 30 extends through two or more of the second openings 401. For example, an intermediate portion of the rope 30 is connected to the actuator 20 inside the receiving cavity 13, and two end portions of the rope 30 respectively extend outside the rope-fixing shell 40 through two different second openings 401, thereby forming a plurality of free ends from a single rope 30. Alternatively, a portion of the rope 30 may be threaded back and forth through two or more second openings 401 to form a multi-loop arrangement. The second openings 401 may be symmetrically or asymmetrically distributed on the rope-fixing shell 40, so that the ropes 30 may extend outward in a symmetrical or asymmetrical arrangement to realize movements of multi-directional and multi-frequency, thereby meeting the needs of the pets of different body sizes and activity levels. The ropes 30 of different lengths or materials may also be used, thereby providing different play experiences.

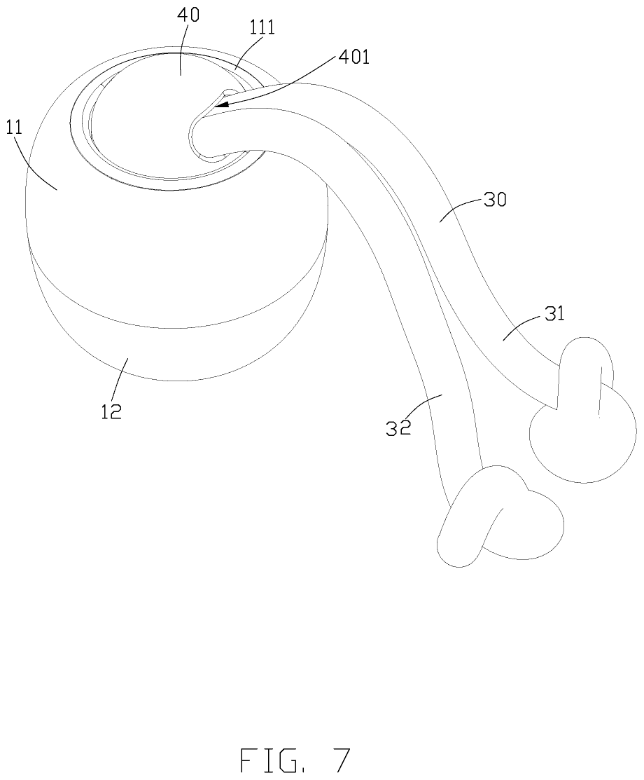

Referring to FIG. 7, in yet another embodiment, the first end 31 and the second end 32 of the rope 30 extending outside the housing 10 are knotted. A distal portion of the knot may be frayed to form a tassel or brush-like structure. Flexible biting attachments, such as soft rubber pieces, fabric strips, or small items containing crinkle paper, may also be threaded onto the rope 30. This may enhance visual and tactile stimulation at the free end of the rope 30 and make it easier to attract the pet to chase and bite.

In at least one embodiment, the first shell 11 and the second shell 12 may each be substantially hemispherical, and may be joined at a circumferential parting plane. A sealing rib or flexible lip seal may be disposed at the circumferential parting plane to inhibit ingress of dust and saliva. This arrangement facilitates assembly, inspection, and cleaning of the actuator 20.

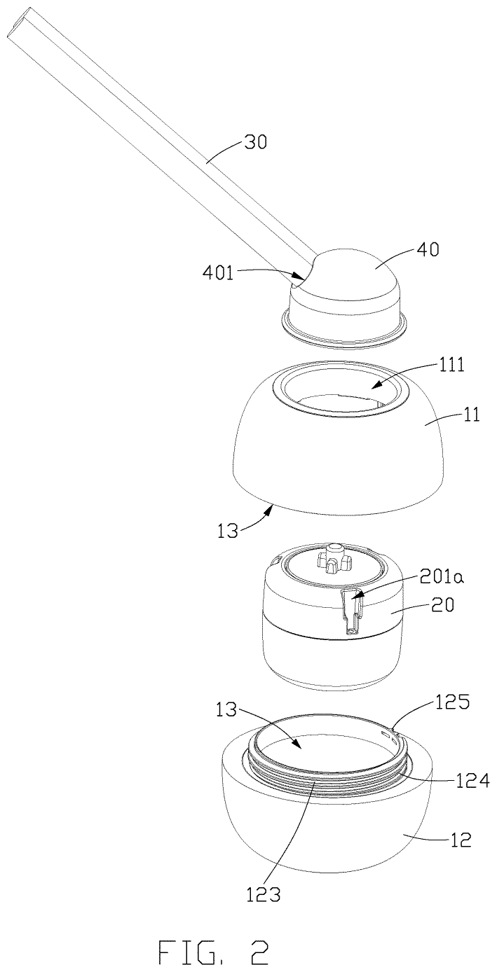

Referring to FIGS. 2, 3, and 5, in at least one embodiment, the first shell 11 includes a first rigid layer 112 and a first elastic layer 113 covering an outer side of the first rigid layer 112. An inner edge of the first rigid layer 112 is provided with an internal thread 114. A portion of the first rigid layer 112 lines an inner wall of the first opening 111. The second shell 12 includes a second rigid layer 121 and a second elastic layer 122 covering an outer side of the second rigid layer 121. The second rigid layer 121 protrudes beyond the second elastic layer 122 to form a connecting portion 123. The connecting portion 123 is provided with an external thread 124. The internal thread 114 engages with the external thread 124.

In other embodiments, the first shell 11 and the second shell 12 may be connected by alternative means, including but not limited to: circumferential snap tabs mating with unlocking windows; a bayonet rotary-lock structure; ultrasonic welding; hot or cold riveting; magnetic positioning supplemented by a mechanical back-stop; or pinning with a decorative cover. These alternatives may be selected according to different manufacturing processes and maintenance requirements.

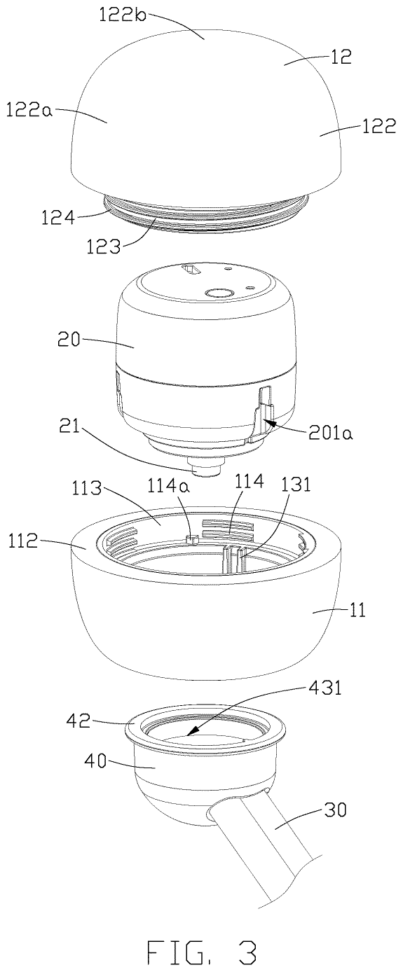

Referring to FIGS. 2 and 3, in at least one embodiment, at least one limiting groove 125 is provided at an outermost end of the external thread 124, and one limiting protrusion 114a is provided at an innermost end of the internal thread 114. The limiting protrusion 114a engages with the limiting groove 125. This engagement may provide a tactile end-position indication and an anti-loosening effect, thereby improving assembly consistency.

In at least one embodiment, the first rigid layer 112 and the second rigid layer 121 are made of engineering plastics capable of withstanding daily impacts, such as acrylonitrile butadiene styrene (ABS), polycarbonate (PC), a polycarbonate/acrylonitrile butadiene styrene (PC/ABS) alloy, polyamide (PA), or polyoxymethylene (POM). Recyclable high-toughness materials may also be used. The first elastic layer 113 and the second elastic layer 122 are made of expanded thermoplastic polyurethane (E-TPU). E-TPU is environmentally friendly, wear-resistant, heat-resistant, low-temperature-resistant, lightweight, highly resilient, and compression-resistant. It can provide cushioning and noise reduction when pets bite or impact the housing 10, and it can improve grip and tactile feel.

Referring to FIG. 5, in at least one embodiment, an outer surface of the second shell 12 includes a contact surface 122b and an arcuate surface 122a surrounding the contact surface 122b. The contact surface 122b and the arcuate surface 122a are smoothly connected. A curvature of the contact surface 122b is less than a curvature of the arcuate surface 122a. The contact surface 122b and the rope 30 are disposed on opposite sides of the housing 10. For example, the contact surface 122b may be substantially planar. The contact surface 122b allows the rope toy 100 to rest stably on a flat surface such as a table or floor. During movement of the rope 30 driven by the actuator 20, the balance of forces is disturbed. Because the arcuate surface 122a surrounds the contact surface 122b, the rope toy 100 readily undergoes irregular self-rotation, thereby producing a random-motion effect that may better stimulate a pet's exploratory instinct.

Referring to FIGS. 2, 3, and 8, in at least one embodiment, an outer side of the actuator 20 is provided with a protrusion 60, and a side of the first shell 11 and/or the second shell 12 facing toward the receiving cavity 13 is provided with a limiting slot 70. The protrusion 60 is received in the limiting slot 70 to restrict rotation of the actuator 20 relative to the housing 10. When the actuator 20 and the housing 10 are engaged in this manner, the actuator 20 may more effectively drive the rope 30 to rotate within the receiving cavity 13. The rotating rope 30 and the arcuate surface 122a located opposite the rope 30 may then cooperate to cause the housing 10 to undergo a random motion effect, thereby improving attraction to a pet. In other embodiments, the arrangement of the protrusion 60 and the limiting slot 70 may be reversed. That is, the outer side of the actuator 20 may define the limiting slot 70, and the side of the first shell 11 and/or the second shell 12 facing toward the receiving cavity 13 may be provided with the protrusion 60 received in the limiting slot 70. In further embodiments, both the outer side of the actuator 20 and the side of the first shell 11 and/or the second shell 12 facing toward the receiving cavity 13 may include a combination of one or more protrusions 60 and one or more limiting slots 70 that engage with each other. Each of these arrangements achieves the same effect of restricting rotation of the actuator 20 relative to the housing 10.

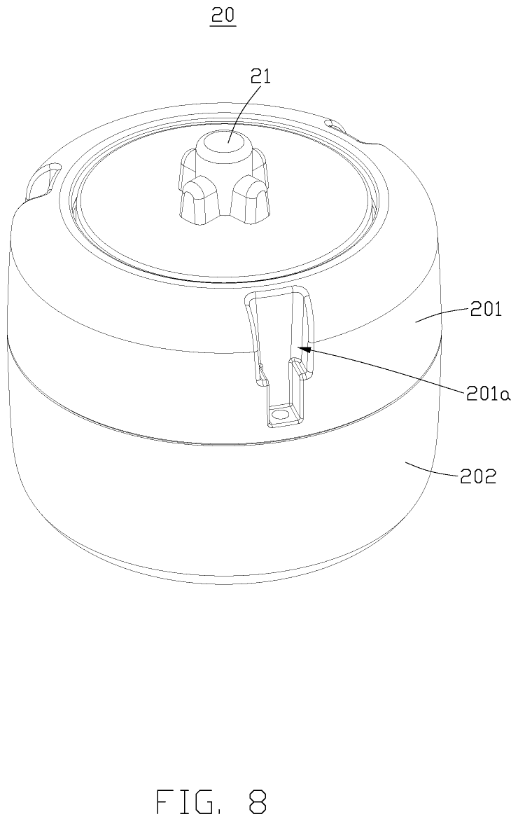

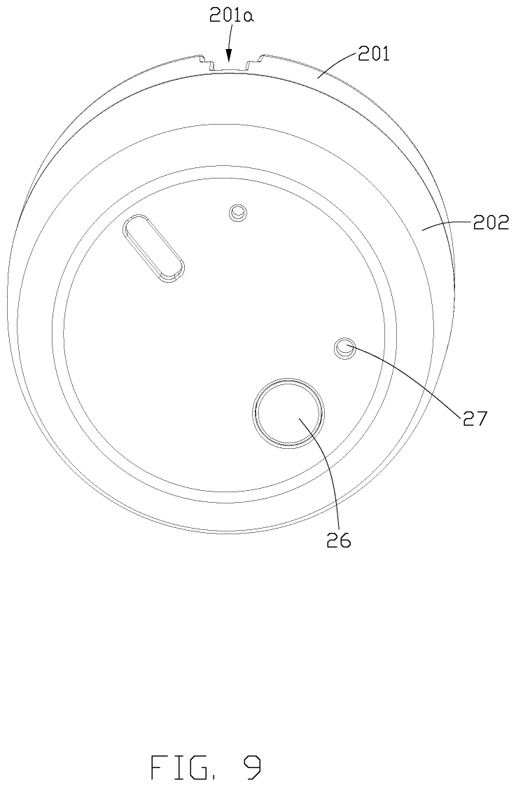

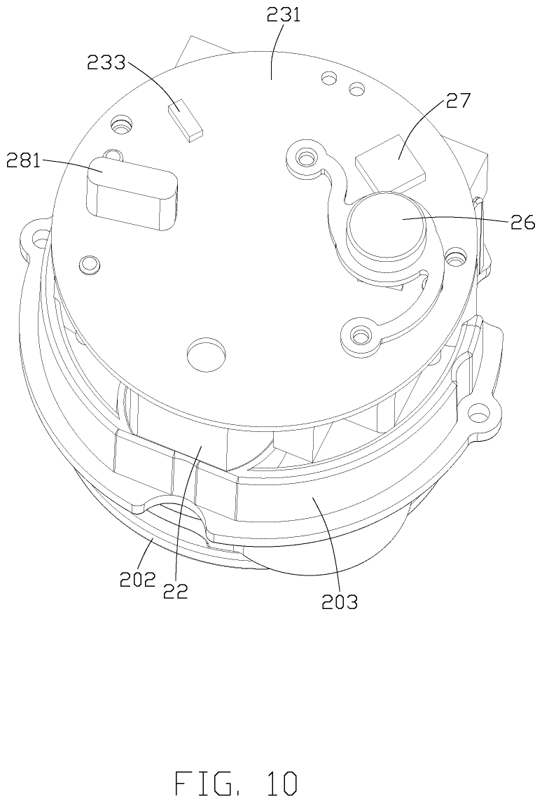

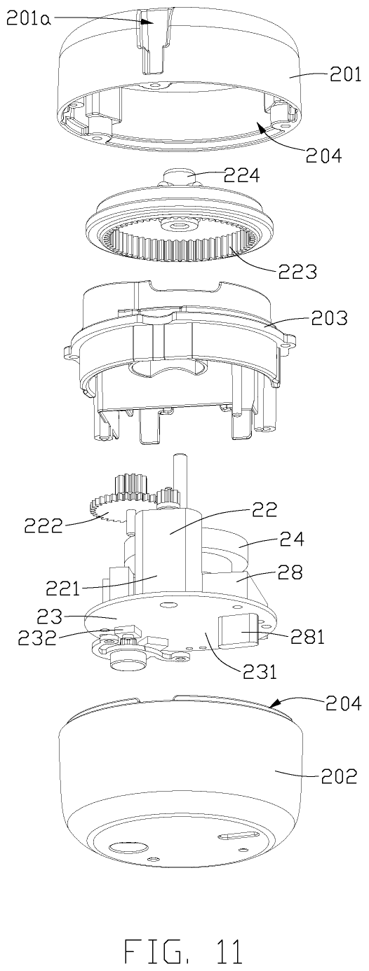

Referring to FIGS. 8, 9, 10, and 11, in at least one embodiment, the actuator 20 includes a top shell 201, a bottom shell 202, a fixing frame 203, a drive assembly 22, and a control assembly 23. The top shell 201 and the bottom shell 202 are connected to define an accommodating space 204. The drive assembly 22 and the control assembly 23 are disposed within the fixing frame 203, and the fixing frame 203 is disposed within the accommodating space 204.

The drive assembly 22 includes a motor 221, an input gear 222, an output gear 223, and an output shaft 224. The input gear 222 is mounted on an output end of the motor 221. The output gear 223 meshes with the input gear 222 and is connected to the output shaft 224. Rotation output by the motor 221 is transmitted by gear engagement to the output gear 223 and then to the output shaft 224, thereby providing stable power output. In some embodiments, the actuator 20 may further include a multi-gear gearbox assembly to enable more precise control of output speed and torque. Forward and reverse rotation of the motor 221 may be used to flexibly switch a rope-whipping direction.

The actuator 20 further includes a battery 28 electrically connected to the drive assembly 22 to supply power thereto. Preferably, the actuator 20 further includes a charging port 281 connected to the battery 28. The charging port 281 is disposed on an outer surface of the actuator 20. After the actuator 20 is removed from the receiving cavity 13 of the housing 10, the charging port 281 becomes accessible so that a user may charge the battery 28 via the charging port 281 without disassembling the actuator 20 itself or replacing the battery 28. To better accommodate a pet-use environment, the charging port 281 may employ a sealable structure together with a flexible waterproof plug so as to enhance resistance to contamination and water ingress.

The actuator 20 may further include a sound unit 24 disposed within the accommodating space 204. The sound unit 24 is configured to emit sound during power output so as to attract a pet and stimulate interaction. The sound unit 24 may be, for example, a buzzer, a speaker, or another compact sound-emitting component. In one example, after the actuator 20 drives the rope 30 in forward and reverse whipping motions for a period of time and then pauses, the sound unit 24 may play an onomatopoeic sound, such as “woof” or “squeak,” or may simulate a pet owner's call, thereby attracting the pet to approach. When the pet touches the toy, the actuator 20 may resume driving the rope 30 to provide an interactive play experience.

The control assembly 23 includes a circuit board 231 and a plurality of electronic components 232. The control assembly 23 controls parameters including starting and stopping of the motor 221, output power, and output duration. To improve reliability, the control assembly 23 may further implement soft start, overcurrent protection, over-temperature protection, stall detection with automatic shutdown, and a low-power or sleep mode activated after a prolonged period without interaction. The control assembly 23 may also be electrically connected to sensors 233, such as a photosensitive sensor 233a and an acceleration sensor 233b. The photosensitive sensor 233a is configured to detect a light level within the receiving cavity 13. When a bright condition is detected, the actuator 20 may determine that the housing 10 is in an assembly or disassembly state and may prevent the motor 221 from starting. When a dark condition is detected, the actuator 20 may determine that the rope toy 100 is in an operational state and may allow the motor 221 to run. The acceleration sensor 233b is configured to detect acceleration of the rope toy 100 caused by pet contact, and a detected signal may be fed back to the control assembly 23 to trigger a new interactive mode.

The actuator 20 may further include a function key 26 and an indicator light 27. The function key 26 and the indicator light 27 are disposed on an outer surface of the actuator 20. The function key 26 is electrically connected to the control assembly 23 and may be used to switch among motion modes. The indicator light 27 may display a current mode or battery status. Motion modes may include a passive mode, a normal mode, and a gentle mode, with different rolling, jumping, or whipping patterns, frequencies, and durations. The indicator light 27 may indicate operating mode and battery status by different colors or blinking patterns. For example, green may indicate passive mode or charging complete, blue may indicate normal mode, purple may indicate gentle mode, rapid red blinking may indicate low battery, and slow yellow blinking may indicate charging in progress.

The embodiments described above are merely examples. Many implementation details are well known in the art and are therefore omitted for conciseness. Although numerous characteristics and advantages of the present technology have been set forth above, the disclosure is illustrative only. Changes may be made in detail, including in the shape, size, and arrangement of parts, within the scope of the present disclosure and the appended claims.

1. A rope toy, comprising:
a housing comprising a first shell and a second shell detachably connected to the first shell, the first shell and the second shell cooperatively defining a receiving cavity;
an actuator removably disposed within the receiving cavity; and
a rope connected to the actuator;
wherein at least one of the first shell or the second shell comprises expanded thermoplastic polyurethane; the rope comprises a first end and a second end opposite the first end, at least one of the first end and the second end extends outside the housing; and the actuator is configured to drive the rope, and in response to the actuator driving the rope, the rope moves relative to at least one of the first shell or the second shell.

2. The rope toy of claim 1, further comprising a rope-fixing shell, wherein the first shell defines a first opening, the first opening communicates the receiving cavity with an external environment, the rope-fixing shell is rotatably disposed in the first opening and defines a second opening, and a portion of the rope extends through the second opening of the rope-fixing shell into the receiving cavity to connect with the actuator.

3. The rope toy of claim 2, further comprising a rope-fixing plate disposed within the receiving cavity, wherein the rope-fixing plate is connected to the actuator and to the rope-fixing shell, and the portion of the rope is disposed between the rope-fixing shell and the rope-fixing plate.

4. The rope toy of claim 2, wherein an edge of the rope-fixing shell extends outwardly to form a limiting flange, and the limiting flange abuts against a portion of the first shell proximate to the first opening.

5. The rope toy of claim 2, wherein an outer side surface of the rope-fixing shell facing away from the receiving cavity protrudes from the first shell, and the outer side surface is curved.

6. The rope toy of claim 3, wherein an inner side surface of the rope-fixing shell facing the receiving cavity is recessed to form a receiving groove, and the portion of the rope and the rope-fixing plate are disposed within the receiving groove.

7. The rope toy of claim 3, wherein the rope-fixing shell comprises a fixing post facing the receiving cavity, the portion of the rope is connected to the fixing post, the rope-fixing plate is connected to the fixing post, the rope-fixing plate comprises a plurality of clamping portions facing the rope, and the plurality of clamping portions abuts against the rope.

8. The rope toy of claim 3, wherein a center region of a side surface of the rope-fixing plate facing away from the rope comprises a spline sleeve, and one end of an output shaft of the actuator comprises a spline meshed with the spline sleeve.

9. The rope toy of claim 1, wherein an outer surface of the second shell comprises a contact surface and an arcuate surface surrounding the contact surface, the contact surface and the arcuate surface are smoothly connected to each other, a curvature of the contact surface is less than a curvature of the arcuate surface, and the contact surface and the rope are disposed on opposite sides of the housing, respectively.

10. The rope toy of claim 1, wherein one of an outer side of the actuator and a side of the at least one of the first shell and the second shell facing the receiving cavity comprises a protrusion, the other one of the outer side of the actuator and the side of the at least one of the first shell and the second shell facing the receiving cavity defines a limiting slot, and the protrusion is disposed within the limiting slot.

11. The rope toy of claim 1, wherein the first shell and the second shell are detachably connected to each other through a threaded connection, the first shell comprises an internal thread and a limiting protrusion, the limiting protrusion is disposed at an innermost end of the internal thread, the second shell comprises an external thread and a limiting groove, the limiting groove is located at an outermost end of the external thread, and the limiting protrusion is engaged with the limiting groove.

12. The rope toy of claim 1, wherein the actuator comprises:
a top shell and a bottom shell connected to each other to define an accommodating space;
a fixing frame disposed within the accommodating space;
a drive assembly disposed within the fixing frame, the drive assembly comprising a motor, an input gear mounted on an output end of the motor, and an output gear meshed with the input gear and connected to an output shaft; and
a control assembly disposed within the fixing frame and electrically connected to the motor.

13. The rope toy of claim 12, wherein the actuator further comprises a battery and a charging port connected to the battery, and the charging port is disposed on an outer surface of the actuator.

14. The rope toy of claim 12, wherein the actuator comprises a sound unit disposed within the accommodating space, and the sound unit is configured to emit sound.

15. The rope toy of claim 12, wherein the actuator further comprises a photosensitive sensor and an acceleration sensor electrically connected to the control assembly, the photosensitive sensor is configured to detect a light level within the receiving cavity, and the acceleration sensor is configured to detect acceleration of the rope toy.

16. The rope toy of claim 1, wherein:
the first shell comprises a first rigid layer and a first elastic layer covering an outer side of the first rigid layer, the first rigid layer comprises an internal thread at an inner edge of the first rigid layer; and
the second shell comprises a second rigid layer and a second elastic layer covering an outer side of the second rigid layer, the second rigid layer protrudes beyond the second elastic layer to form a connecting portion, and the connecting portion comprises an external thread engaging with the internal thread.

17. The rope toy of claim 3, further comprising a latch block protruding from an inner side surface of the rope-fixing shell, an outer edge of the rope-fixing plate defines a latch slot, and the latch block is retained within the latch slot.

18. The rope toy of claim 2, wherein the rope-fixing shell defines a plurality of second openings, and the rope extends through at least one of the plurality of second openings.

19. The rope toy of claim 12, wherein the actuator further comprises a function key electrically connected to the control assembly and an indicator light, the function key and the indicator light are disposed on an outer surface of the actuator, the function key is configured to switch the rope toy among different motion modes, and the indicator light is configured to display a current motion mode of the motion modes or a battery status.

20. The rope toy of claim 1, wherein the first end and the second end of the rope extending outside the housing are knotted.
